(19) United States
(12) Patent Application Publication
(10) Pub. No.: US 2025/0294591 A1
(43) Pub. Date: Sep. 18, 2025

(54) METHOD AND DEVICE FOR MINIMIZING IMPACTS OF SIDELINK TRANSMISSION IN USER EQUIPMENT DOWNLINK SLOTS

(71) Applicant: Samsung Electronics Co., Ltd., Gyeonggi-do (KR)

(72) Inventors: Mohamed Mokhtar Gaber Moursi AWADIN, San Diego, CA (US); Yaser Mohamed Mostafa Kamal FOUAD, San Diego, CA (US); Philippe Jean Marc Michel SARTORI, Naperville, IL (US)

(21) Appl. No.: 19/057,379

(22) Filed: Feb. 19, 2025

Related U.S. Application Data
(60) Provisional application No. 63/565,895, filed on Mar. 15, 2024.

(51) Int. Cl. H04W 72/25; H04B 7/06; H04W 24/10; H04W 72/0446; H04W 72/23; H04W 74/0808

(52) U.S. Cl. CPC H04W 72/25; H04B 7/0626; H04W 24/10; H04W 72/0446; H04W 72/23; H04W 74/0825

(57) ABSTRACT

A method and device are provided in which the device designates a downlink (DL) slot of an uplink (UL)-DL slot configuration period for sidelink (SL) transmission. The device receives, from a gNode B (gNB), an indication of a permission status of the SL transmission. The device updates the permission status of the SL transmission based on the indication.

### CROSS-REFERENCE TO RELATED APPLICATION

This application claims the priority benefit under 35 U.S.C. § 119(e) of U.S. Provisional Application No. 63/565,895, filed on Mar. 15, 2024, the disclosure of which is incorporated by reference in its entirety as if fully set forth herein.

### TECHNICAL FIELD

The disclosure generally relates to sidelink (SL) transmissions between user equipments (UEs). More particularly, the subject matter disclosed herein relates to improvements to SL transmissions in downlink (DL) slots over a Uu interface.

### SUMMARY

In new radio (NR) Release-17/Release-18, SL transmissions are restricted to uplink (UL) slots. This restriction was primarily introduced to protect DL transmissions from potential interference caused by neighboring SL transmissions. While this approach helps maintain the integrity of DL communications, it imposes a significant limitation on the available resources for SL transmissions. As a result, SL-based applications, such as vehicle-to-vehicle (V2V) communication for autonomous driving, which may need to share raw sensing information among neighboring vehicles, may not be able to meet stringent requirements on latency and throughput. The impact of this constraint is particularly pronounced in scenarios where the number of UL slots per subframe is significantly lower than the number of DL slots, leading to inefficient SL resource utilization.

To solve this problem, a potential solution is to allow SL transmissions in DL slots while managing interference with DL transmissions. Preliminary assessments of this approach suggest that interference from SL transmissions on neighboring DL transmissions over the Uu interface may be minimal due to the limited transmission power and short communication range of SL devices, (e.g., approximately 10 meters). Allowing SL transmissions in DL slots could improve SL resource availability, enhance data throughput, and reduce latency. As shown with respect to FIG. 1, this is also applicable to ambient Internet of things (IoT) devices. Specifically, ambient IoT device transmissions may originate from a device 102 and be transmitted on the SL toward a neighboring intermediate node 104, which is in communication with a base station or a next generation node-B (gNB) 106. Similarly, the intermediate node 104 may also perform SL transmissions toward neighboring ambient IoT devices 102.

One issue with the above approach is the potential cross-link interference between SL and Uu DL transmissions, which could degrade the performance of a regular UE receiving DL transmissions. Additionally, when a UE conducts channel measurements based on channel state information-reference signals (CSI-RSs) or synchronization signal blocks (SSBs), the interference introduced by SL transmissions can lead to inaccurate measurements and unreliable channel estimations. Moreover, resource conflicts may arise when a UE is scheduled for both DL reception and SL transmission within the same slot, which cannot be performed concurrently due to a half duplex constraint on the UE. Without proper mechanisms for managing these collisions, SL transmissions in DL slots may disrupt the reliability of DL communications.

To overcome these issues, systems and methods are described herein for enabling SL transmissions in DL slots while minimizing their impact on Uu DL transmissions. The described techniques include Mode 1 and Mode 2 resource selection mechanisms that allow SL transmissions to coexist with DL transmissions without excessive interference. A preemption technique is introduced, enabling a gNB to trigger a resource selection process for SL transmissions that conflict with scheduled DL transmissions. Furthermore, enhanced collision handling mechanisms are provided to mitigate the impact of SL transmissions on DL transmissions, including procedures for managing CSI reporting when SL transmissions overlap with measured RSs. The invention also proposes specific UE behaviors for handling collisions between SL communications and critical DL signals, such as SSBs and tracking reference signals (TRS).

The above approaches improve on previous methods because they enable SL transmissions in DL slots while preserving the integrity of Uu DL communications. By implementing preemption mechanisms, SL transmissions may be dynamically managed to minimize interference with DL transmissions. Additionally, the proposed collision handling procedures improve the reliability of DL measurements by reducing signal degradation caused by SL transmissions. The invention also introduces signaling optimizations, such as allowing SL UEs to indicate out-of-coverage status to reduce unnecessary cancellation signaling. These improvements collectively enhance the efficiency and reliability of SL communications while ensuring minimal disruption to DL transmissions.

In an embodiment, a method is provided in which a UE designates a DL slot of an UL-DL slot configuration period for a SL transmission. The UE receives, from a gNB, an indication of a permission status of the SL transmission. The first UE updates the permission status of the SL transmission based on the indication.

In an embodiment, a method is provided in which a UE identifies collision instances of DL RS reception and SL transmission in an UL-DL slot configuration period. The UE identifies non-collision instances of DL RS reception. The UE measures CSI based on at least one of the collision instances and the non-collision instances.

In an embodiment, an electronic device is provided that includes a processor and a non-transitory computer readable storage medium storing instructions. When executed, the instructions cause the processor to designate a DL slot of a UL-DL slot configuration period for SL transmission, receive, from a gNB, an indication of a permission status of the SL transmission, and update the permission status of the SL transmission based on the indication.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating SL transmissions in ambient IoT systems;

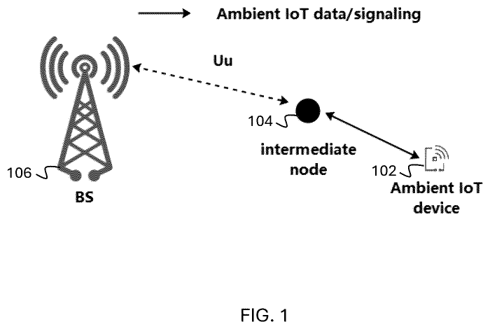

FIG. 2 is a diagram illustrating DL reception and SL transmission by a vehicular UE (vUE);

FIG. 3 is a diagram illustrating cancellation of an SL transmission in a DL slot, according to an embodiment;

FIG. 4 is a diagram illustrating cancellation of an SL transmission in a DL slot in a particular SL subchannel, according to an embodiment;

FIG. 5 is a diagram illustrating periodic or semi-persistent cancellation of an SL transmission in a DL slot in a particular SL subchannel, according to an embodiment;

FIG. 6 is a diagram illustrating a clear-to-transmit indication for an SL transmission in DL slots, according to an embodiment;

FIG. 7 is a diagram illustrating release of a future preempted resource due to gNB cancellation, according to an embodiment;

FIG. 8 is a diagram illustrating relaying of gNB SL resource cancellation to out of coverage vUEs, according to an embodiment;

FIG. 9 is a flowchart illustrating a method for managing SL transmission in a DL slot, according to an embodiment;

FIG. 10 is a diagram illustrating division of DL RSs into two groups based on a collision with an SL transmission, according to an embodiment;

FIG. 11 is a diagram illustrating a pattern of time resources at which an SL transmission occurs, according to an embodiment;

FIG. 12 is a flowchart illustrating a method for collision handling between DL RS reception and SL transmission, according to an embodiment; and

FIG. 13 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/of” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

With respect to NR, a gNB may schedule a DL transmission to a first UE, and later ultra-reliable low latency communications (URLLC) traffic for a second UE may arrive at the gNB. If there are enough resources in either the time domain or the frequency domain, the gNB may simultaneously schedule the DL transmissions for both the first UE and the second UE. However, if there are insufficient resources, the gNB may preempt some of the resources allocated to the first UE to re-utilize them for scheduling the second UE.

Although hybrid automatic repeat request (HARQ) retransmission may be able to handle this situation, it may not be very efficient. Specifically, the first UE may fail in decoding the allocated grant because some of the resources originally allocated to the first UE contain data for the second UE. The first UE may transmit a negative acknowledgement (NACK) and the gNB 104 may reschedule for the first UE. However, the first UE wastes power in attempting to decode data that is allocated to another UE and corrupts its HARQ soft buffer with data transmitted to another UE.

Instead, the gNB may transmit a DL preemption indication that points to the resources that will be preempted. The preemption is transmitted in a slot after the slot containing the data to be preempted. DL control information (DCI) format 2_1 may be used for this purpose, and may be carried in a physical DL control channel (PDCCH) with a cyclic redundancy check (CRC) scrambled by an interruption (INT)-radio network temporary identifier (RNTI).

DCI format 2_1 may be carried via a group common (GC)-PDCCH addressing multiple groups of UEs configured with the same INT-RNTI. Each group of UEs may extract the corresponding chunk of information bits based on positionInDCI, which indicates the location of the chunk in DCI format 2_1.

The preemption information for each group of UEs may be 14 bits. The period between any two monitoring occasions of PDCCH carrying DCI format 2_1 may be divided into 14 time intervals. If a bit is set to “1”, then the entire corresponding time interval may be pre-empted across a full bandwidth part (BWP).

Alternatively, the period between any two monitoring occasions of PDCCH carrying DCI format 2_1 may be divided into 7 time intervals and the frequency of DL BWP may be divided into two parts. In this case, the 14 bits may be used to indicate which time interval and which half of the DL BWP is pre-empted.

Upon receiving preemption, although the UE's behavior is not specified, reasonable UE behavior may include flushing the part of the soft buffer corresponding to the preempted time-frequency region to avoid soft-buffer corruption for future retransmissions.

Similarly, with respect to uplink cancellation, if a gNB already provided an UL grant for a UE having a low priority UL transmission compared to another UE, the gNB may need to cancel the grant of the UE to free resources to the other UE. This may be beneficial in a system in which the gNB is not be able to serve both UEs concurrently.

The UL cancellation indication may be carried via DCI format 2_4 scrambled with cancellation indication (CI)-RNTI. The information bits may be similar to those in DCI format 2_1 for indicating a set time interval within a time region and resource blocks (RBs) upon which UL transmissions should be cancelled. Specifically, the time region may be configured or equal to the PDCCH monitoring periodicity of DCI 2_4. For frequency domain location, the gNB may provide the UE with the location of a set of RBs that may be cancelled. Each bit may correspond to one of the time domain intervals.

Upon reception, the UE may stop the transmission of a physical UL shared channel (PUSCH) or a sounding reference signal (SRS) that fully or partially overlaps with the indicated cancelled resources. The UE may require time to process the cancellation indication and adjust the UL transmission accordingly. Specifically, the ongoing PUSCH may not be stopped, unless the PUSCH is repeated. In this case, some repetitions may be cancelled if the timeline is satisfied.

With respect to a CSI-RS configurations, in order to provide a UE with the configuration parameters of the CSI-RS, a gNB may use nested radio resource control (RRC) information elements (IEs) and another portion of the configuration may be provided based on the activation method.

Specifically, a CSI-ResourceConfig IE may include, but is not limited to NZP-CSI-RS-ResourceSet, CSI-SSB-ResourceSet, and CSI-IM-ResourceSet, and the corresponding time domain behavior of the resources within these lists, in terms of periodic, semi-persistent, and periodic.

The NZP-CSI-RS-ResourceSet may include, but is not limited to, NZP-CSI-RS-Resource and an indication of whether the UE can assume that all NZP-CSI-RS-Resource within the set are transmitted using the same DL beam (i.e., repetition is “on”). For aperiodic CSI-RS, an offset of X slots between DCI triggering a set of aperiodic non-zero power (NZP) CSI-RS resources and the slot in which the CSI-RS resource set may be transmitted (i.e., aperiodicTriggeringOffset).

For different reporting quantities, if RRC parameter timeRestrictionForChannelMeasurements or timeRestrictionForInterferenceMeasurements is set to “configured”, the UE may derive the indicated channel or interference measurements using the most recent (no later than the CSI reference resource) occasion of an SSB or a CSI-RS. When the parameter is set to “notconfigured”, the UE implementation may determine which SSB(s) or CSI-RS(s) (and whether to average them or not), no later than the CSI reference resource, to derive the indicated channel or interference measurements.

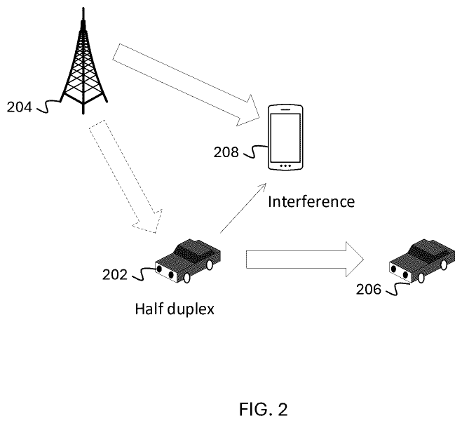

FIG. 2 is a diagram illustrating DL reception and SL transmission by a vUE. Specifically, a half duplex vUE 202 may not be expected to simultaneously receive a DL transmission from a gNB 204 and transmit SL information to a neighboring UE 206. However, the half duplex UE 202 may perform SL transmissions in DL slots in which it does not expect to receive a DL transmission.

This scenario may significantly improve throughput for SL transmission and may reduce latency by allowing more slots per subframe to be used for SL transmissions.

As described above, in NR SL design, SL transmissions are restricted to UL slots. Consequently, SL throughput may be degraded and the latency may be increased. However, these disadvantages may be overcome if SL transmissions are also permitted in DL slots.

Nevertheless, it is important that the gNB 204 protect a regular UE 208, receiving DL transmission from the gNB 204, from any potential cross link interference caused by an SL transmission in the same slot. For example, procedures are needed for the gNB 204 to preempt/authorize an SL transmission in DL slots based on the impact to the regular UE 208.

Additionally, when the regular UE 208 performs channel measurements (e.g., based on CSI-RS or SSB), the interference statistics may vary from one instance to another depending on the existence or absence of an SL transmission. Therefore, a need exists for enhancing a channel measurement framework to reduce the impact of the SL transmission on such measurements.

In accordance with an embodiment, the gNB 204 may dynamically enable/disable an SL transmission in DL slots/symbols when DL transmissions for the regular UE 208 are negatively affected by the SL transmission in the DL slots/symbols. Specifically, performing the SL transmission in DL slots may not only depend on factors related to SL, but may also depend on the impact to regular UEs receiving a DL transmission.

The gNB 204 may transmit a UE-specific or GC indication, such as, for example, a UE-specific PDCCH or GC-PDCCH, to dynamically enable/disable the SL transmission in the DL slots/symbols that were initially indicated to carry the SL transmission. Dedicated scrambling RNTI may be used when GC-PDCCH is used. Alternatively, cell (C)-RNTI may be used for UE-specific PDCCH.

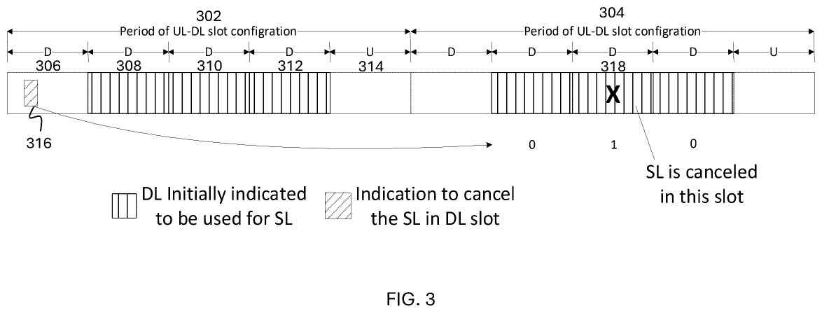

FIG. 3 is a diagram illustrating cancellation of an SL transmission in a DL slot, according to an embodiment. More specifically, FIG. 3 illustrates an example of multiple UL-DL slot configuration periods 302, 304, having five slots, in which the first four slots, 306, 308, 310, 312, are indicated as DL, and a last slot 314 is indicated as UL (i.e., DDDDU).

Referring to FIG. 3, initially, an SL transmission is allowed in the second DL slot 308, the third DL slot 310, and the fourth DL slot 312. In the first UL-DL slot configuration period 302 (e.g., the first DL slot 306), the gNB may transmit an indication 316 (e.g., GC-PDCCH) to override such configurations.

The indication may carry a bitmap in which each bit may correspond to a particular time unit (e.g., DL slot/symbol, the entire UL-DL configuration period, subframe, etc.).

The bitmap may be applied only to the slot/symbols indicated to have SL transmission which may be beneficial to reduce the payload. To further reduce the payload, each bit may correspond to all SL transmissions in a time period. Particularly, a single bit may correspond to the whole UL-DL slot configuration period. In this case, all SL transmissions within this period may be cancelled.

At the end of the duration indicated by the bitmap, SL transmissions may resume to occur in the DL slots/symbols based on the earlier configuration. Alternatively, this bitmap may be priority dependent based on (pre-)configuration, in which only the low priority SL transmissions are impacted by the bitmap and their intended SL transmissions are cancelled.

The bitmap may be applied after a time gap relative to the reception of the indication.

Referring back to FIG. 3, the indication 316 may applied to the next UL-DL slot configuration period 304 and an SL transmission may be cancelled in a third DL slot 318. This may be beneficial to provide the UE with some time to receive and decode the indication. Additionally, the applicability of the time gap may be similar to the time needed to receive a physical DL shared channel (PDSCH) or to apply the indicated beam in a unified transmission configuration indicator (TCI) state framework.

Rather than using a bitmap, the indication may directly indicate the time duration at which SL transmission within DL slots/symbols is cancelled (e.g., via a PDCCH). For example, the indication may provide information on the start and length of the period in which SL transmission within DL slots/symbols is cancelled. This may be the form of a start and length indicator value (SLIV). Specifically, the gNB may configure multiple SLIVs via higher layer signaling, similar to a time domain resource allocation (TDRA) table. The indication may indicate which row it is to be applied (e.g., via a GC-PDCCH). Alternatively, the indication may indicate the start and length (the end) of the period in which SL transmission may be cancelled.

To further enhance scheduling flexibility, the gNB may cancel an SL transmission in a DL slot in particular frequency resources having a granularity of a subchannel, an RB, a component carrier (CC), etc.

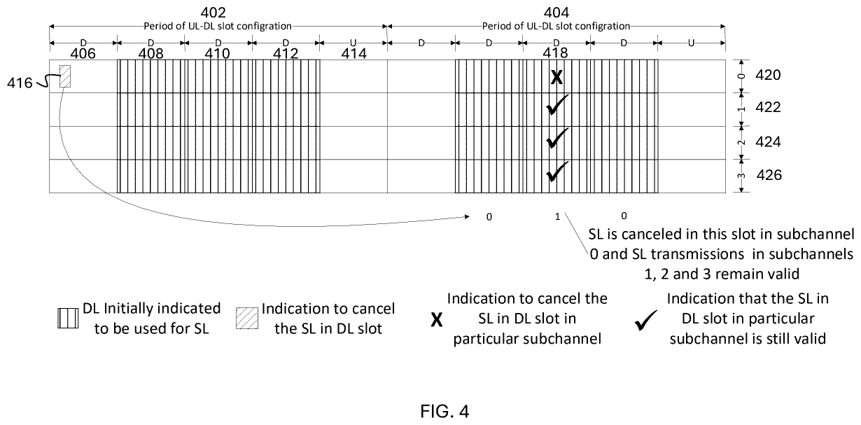

FIG. 4 is a diagram illustrating cancellation of an SL transmission in a DL slot in a particular SL subchannel, according to an embodiment. Accordingly, another bitmap may be introduced in which each bit may correspond to a particular frequency domain resource. For example, each bit may correspond to a particular SL subchannel. A least significant bit (LSB) may correspond to the lowest SL subchannel index.

More specifically, FIG. 4 illustrates an example of multiple UL-DL slot configuration periods 402, 404, having five slots and four subchannels. The first four slots, 406, 408, 410, 412, are indicated as DL, and a last slot 414 is indicated as UL (i.e., DDDDU).

Initially, an SL transmission is designated in the second DL slot 408, the third DL slot 410, and the fourth DL slot 412, across all four subchannels 420, 422, 424, 426. In the first UL-DL slot configuration period 402 (e.g., the first DL slot 406 and first subchannel 420), the gNB may transmit an indication 416 (e.g., GC-PDCCH) to override such configurations. The indication 416 may applied to the next UL-DL slot configuration period 404 and an SL transmission may be cancelled in a third DL slot 418 in the first subchannel 420. SL transmission in the second subchannel 422, the third subchannel 424, and the fourth subchannel 426 of the third DL slot 418 remain valid.

The indication corresponding to the time domain resources and frequency domain resources at which SL transmission in DL slots is cancelled, may be carried via higher layer signaling, such as, for example, RRC signaling or a medium access control (MAC)-control element (CE).

In the absence of the indication of frequency domain resources of the SL to be cancelled, all SL transmissions within the CC or BWP may be cancelled in the indicated time domain resources.

It may be beneficial for the indicated cancellation to be applied periodically or semi-persistently to protect periodic and semi-persistent DL transmission of a regular UE. The periodicity may be in units of a symbol, a slot, a subframe, or an UL-DL slot configuration period. The periodicity may be provided via higher layer signaling (e.g., RRC signaling).

For SL cancellation based on RRC signaling, the indication may carry information on the time domain resources, the frequency domain resources, and their periodicity. The aforementioned solutions or any other solutions for indicating the time domain resources and the frequency domain resources may be applied.

For SL cancellation based on MAC-CE signaling, higher layer signaling, such as RRC signaling, may configure multiple groups of the resources to be cancelled, with each group consisting of the time domain resources, the frequency domain resources, and their periodicity. To facilitate the MAC-CE indication, each group may be associated with an index and a MAC-CE may indicate the group index to be activated/applied.

Table 1 shows an example of RRC configurations and the association of each group of resources to an index to be indicated via MAC-CE. Additional information may be included in each group, such as an applicable subcarrier spacing (SCS). Although Table 1 shows that the time domain resources and frequency domain resources are indicated via a bitmap, other solutions described herein or other possibilities for indicating the time domain resources and frequency resources may also be utilized.

TABLE 1

| Index | Resources information for cancelling SL transmission in DL slots |
|---|---|
| 0 | Periodicity: every UL-DL slot configuration period |
| | Time domain resources: 010 referring to cancelling SL in the second DL slot |
| | Frequency domain resources: 1000 referring to cancelling SL in the subchannel |
| | #0 |
| 1 | Periodicity: every other UL-DL slot configuration period |
| | Time domain resources: 100 referring to cancelling SL in the first DL slot |
| | Frequency domain resources: 1100 referring to cancelling SL in the subchannel |
| | #0 and #1 |
| 2 | Periodicity: every x slots |
| | Time domain resources: 100 referring to cancelling SL in the first DL slot |
| | Frequency domain resources: 1100 referring to cancelling SL in the subchannel |
| | #0 and #1 |
| . . . | . . . |

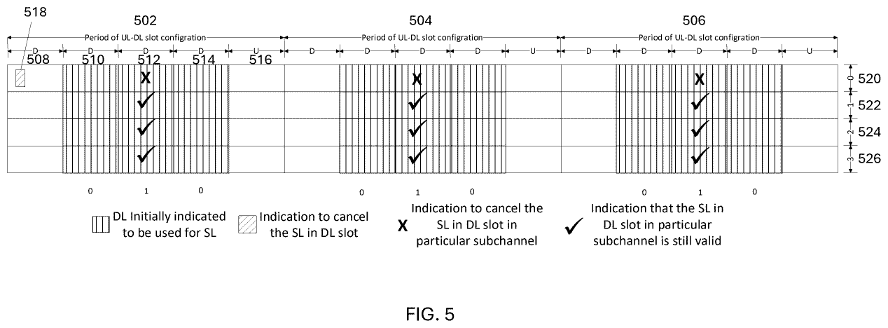

FIG. 5 is a diagram illustrating periodic or semi-persistent cancellation of an SL transmission in a DL slot in a particular SL subchannel, according to an embodiment. More specifically, FIG. 5 illustrates an example of an indication carried via RRC or MAC-CE. The periodicity is every UL-DL slot configuration period, meaning that the indicated pattern of the SL transmission to be cancelled may be repeated until RRC release or MAC-CE deactivation. The pattern in each period may be provided via the time domain resources and frequency domain resources.

More specifically, FIG. 5 illustrates an example of multiple UL-DL slot configuration periods 502, 504, 506, each having five slots and four subchannels. The first four slots, 508, 510, 512, 514, are indicated as DL, and a last slot 516 is indicated as UL (i.e., DDDDU).

Initially, an SL transmission is designated in the second DL slot 510, the third DL slot 512, and the fourth DL slot 514, across all four subchannels 520, 522, 524, 526. In the first UL-DL slot configuration period 502 (e.g., the first DL slot 508 and first subchannel 520), the gNB may transmit an indication 518 (e.g., RRC or MAC-CE) to override such configurations. The indication 518 may applied to each of the UL-DL slot configuration periods, and an SL transmission may be cancelled in the third DL slot 512 in the first subchannel 520. An SL transmission may also be cancelled in the third slot of the subsequent UL-DL slot configuration periods 504 and 506. SL transmission in the second subchannel 522, the third subchannel 524, and the fourth subchannel 526 of the third DL slot 512 remain valid.

Referring to FIG. 5, the time domain resource is 010 indicating to cancel an SL transmission in the second of the three DL slots allowing SL transmission in each period, while the frequency domain resources is 1000 indicating to cancel an SL transmission in the first of the four subchannels allowing SL transmission in each period.

The vUE may require time to process the cancellation of the SL transmission depending on how the indication is carried. For example, for an indication based on a MAC-CE, the indicated information may be applied starting from a first slot that is after slot n+3 Nₛₗₒₜ^{subfram,μ}, where n refers to the slot that the vUE would transmit HARQ-acknowledgement (ACK) information corresponding to the PDSCH carrying the MAC-CE, and is the SCS configuration for the channel carrying the HARQ-ACK information on the Uu interface.

For an indication carried via a PDCCH, the indication may be applied after k time units from the reception of the PDCCH, and may be in a unit of a symbol, a slot, a subframe, a UL-DL slot configuration period, etc. The value of k may be predefined (e.g., provided in the specification), or indicated to the gNB via UE capability signaling.

Cancelling an SL transmission may refer to cancelling of SL transmissions including a physical SL shared channel (PSSCH), a physical SL control channel (PSCCH), an SL CSI-RS, etc., or a subset of such channels that may be predefined.

The complementary of the aforementioned SL cancellation operations may be valuable as well. For example, although the vUEs may have already received the configurations of which DL slots can be used for SL transmissions, the vUEs may not transmit an SL unless they receive a clear-to-transmit indication from the gNB. The aforementioned operations may be extended by replacing the cancellation indication with clear-to-transmit indication. When no explicit indication of clear-to-transmit (e.g., via a DCI, a MAC-CE, or RRC signaling) is provided for the DL slots that were initially indicated to be used for SL transmission, the vUE may assume that no SL transmission may be transmitted in those DL slots.

Additionally, the aforementioned timeline for cancelling an SL transmission in DL slots may be applied for the case of clear-to-transmit.

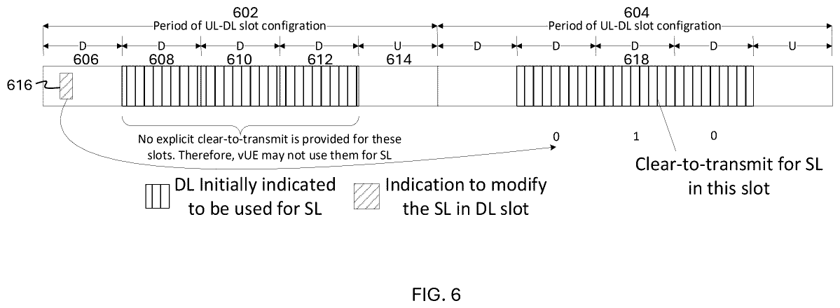

FIG. 6 is a diagram illustrating a clear-to-transmit indication for an SL transmission in DL slots, according to an embodiment.

More specifically, FIG. 6 illustrates an example of multiple UL-DL slot configuration periods 602, 604, having five slots. The first four slots, 606, 608, 610, 612, are indicated as DL, and a last slot 614 is indicated as UL (i.e., DDDDU).

Initially, an SL transmission is not allowed in the second DL slot 608, the third DL slot 610, and the fourth DL slot 612, as no clear-to-transmit indication has been received. In the first UL-DL slot configuration period 602 (e.g., the first DL slot 606), the gNB may transmit a clear-to-transmit indication 616 (e.g., GC-PDCCH). The clear-to-transmit indication 616 may applied to the next UL-DL slot configuration period 604.

Accordingly, in the first UL-DL slot configuration period 602, no explicit indication is provided, and the vUE may refrain from transmitting an SL in the DL slots 608, 610, and 612 that were initially indicated as a candidate to carry an SL transmission. In the second UL-DL slot configuration period 604, the vUE may transmit an SL in a third DL slot 618 and refrain from transmitting the SL in other DL slots, based on the clear-to-transmit indication 616 on a particular DL slot 618.

Although this embodiment illustrates a clear-to-transmit indication is carried in a PDCCH, it may also be carried via a MAC-CE or RRC signaling, as described above with respect to the cancellation indication.

When a GC-PDCCH is used to carry the cancellation indication or clear-to-transmit, it may carry multiple indications for multiple vUE groups. Each group should have knowledge of the location of the corresponding field in the GC-PDCCH. For example, the gNB may provide each group of vUEs with the field location in the GC-PDCCH via higher layer signaling (e.g., positionInDCI). Alternatively, each UE within a particular group may derive the field location in the GC-PDCCH. Rules may be applied based on a UE ID or a group ID. For example, a rule may define the field number in the GC-PDCCH as equal to the group number. Specifically, the vUEs in the first group may apply the information provided in the first field (e.g., the field has the MSB), the vUEs in the second group may apply the information provided in the second field after the first field, and so on.

The gNB may indicate the number of groups addressed by a GC-PDCCH. In this case, the vUE may determine the location (or the index) of the corresponding field in the DCI by, for example, module (group number, number of groups addressed by GC-PDCCH). In this approach, all the fields may have the same size. The size of the field may be predefined in the specification.

Alternatively, the gNB may provide indications to vUEs via higher layer signaling. Furthermore, the vUEs may derive the size of the field. For example, if an SLIV approach is used, the field size may depend on the associated configured TDRA table. For example, if the associated TDRA table has 16 rows of SLIV values, then the field may have 4 bits. In addition to the GC-PDCCH, a UE-specific PDCCH may be used to indicate DL slots that can be used for SL transmission.

The vUE may identify movement out of gNB coverage through measurements (e.g., reference signal received power (RSRP), received signal strength indicator (RSSI)) based on an RS being below a threshold that may be predefined (e.g., provided in the specification, or configured by higher layer signaling). When out of the gNB coverage, the vUE may transmit an indication to the gNB, notifying the gNB that it has moved out of gNB coverage. The vUE may use a physical random access channel (PRACH), UL control information (UCI), or a MAC-CE to indicate that it has moved out of gNB coverage. For example, the gNB may configure dedicated PRACH resources to carry such indication via higher layer signaling. Alternatively, contention-based PRACH may be used, in which case, a new MAC-CE may be used to indicate that the purpose of the PRACH transmission is movement out of gNB coverage. As another alternative, the UE may transmit a scheduling request (SR) to explicitly indicate movement out of gNB coverage or to obtain PUSCH resources to transmit a MAC-CE indicating movement out of gNB coverage.

From the SL perspective, the cancellation of a future SL transmission by the gNB may either trigger a resource reselection or a pre-emption. In particular, if SL control information (SCI) was previously transmitted indicating a reservation on a DL slot that it is not accessible due to a gNB cancellation, or the absence of a clear-to-transmit indication, then a pre-emption may be triggered to find replacement resources. On the other hand, if the cancelled SL resource on a DL slot was not indicated, a resource reselection may not be triggered. In other words, the gNB cancellation of SL slot(s) may be considered one of the possible triggers for the pre-emption and resource reselection procedures.

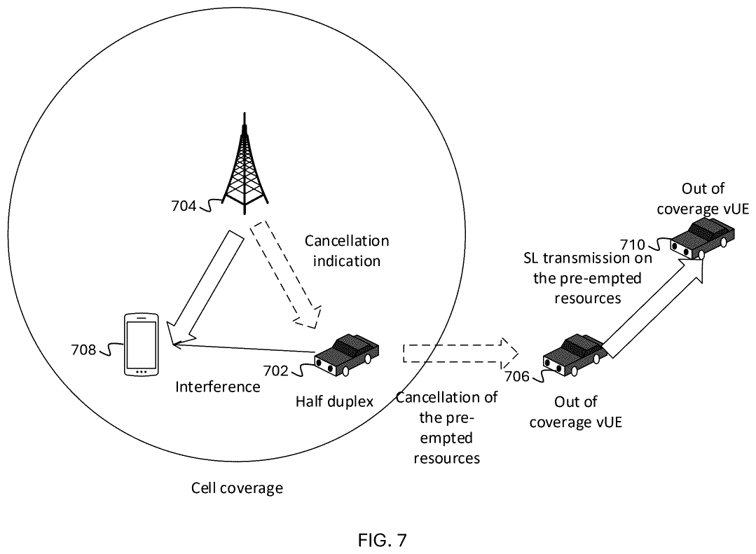

FIG. 7 is a diagram illustrating release of a future preempted resource due to gNB cancellation, according to an embodiment. As described above, a gNB 704 may protect a regular UE 708, receiving DL transmission from the gNB 704, from any potential cross link interference caused by a SL transmission in the same slot from a half duplex vUE 702, by preempting the SL transmission based on the impact to the regular UE 708 through a cancellation indication. The half duplex vUE 702 may cancel the SL transmission on some SL resources and forward this information to a second vUE 706. The second vUE 706 may then perform SL transmission on the previously preempted resources to a third vUE 710 that is also out of the coverage area of the gNB 704.

Accordingly, to further improve the resource utilization, in case of a preemption, the release of a future resource, for cell edge vUEs, may indicate through SCI signaling that future SL resources are freed. For example an out of coverage SL vUE may be blocked by the SCI reservation, in case of a periodic reservation/cancellation.

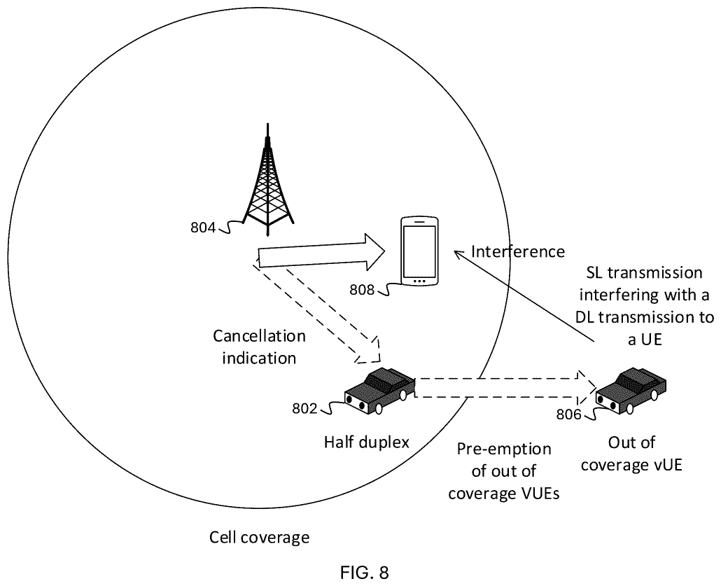

FIG. 8 is a diagram illustrating relaying of gNB SL resource cancellation to out of coverage vUEs, according to an embodiment.

As shown in FIG. 8, a half duplex vUE 802 that received a cancellation indication from a gNB 804 to cancel a future periodic or semi-persistent reservation can forward that cancellation in its SCI to a neighboring vUE 806 that is out of the coverage area of the gNB 804. In this case, this resource may have been used by out of coverage vUEs for SL transmissions. The forwarding of the cancellation indication may be achieved by adding a new field in the SCI (e.g., a field to indicate that the future resources indicated by the associated time resource indicator value (TRIV) and frequency resource indicator value (FRIV) fields are cancelled rather than reserved). Alternatively, a new 1^{st} or 2^{nd} stage SCI or a MAC CE may be used to carry the released future resources similar to the resource selection assistance. In particular, additional TRIV/FRIV fields can be added to the 2^{nd} stage SCI or by using a MAC CE to indicate the future released resources that can be used by the neighboring out of coverage vUEs for SL transmissions.

Unlike the previous case, the gNB 804 may request the cell edge half duplex vUE 802 to relay the cancellation of a future SL reservation. The out of coverage vUE 806 (e.g., in a tunnel) may not be able to detect the gNB indication and may still perform an SL transmission, thereby impacting a neighboring DL device 808, as shown in FIG. 8.

The request to relay the cancellation signal from the gNB 804 may be indicated along with the cancellation signal sent from the gNB 804 as described above. For example, a new one-bit field may be added to request the vUE 802 to forward the cancellation request to their neighboring vUE 806. To preserve resources, this relaying may be restricted to cell edge vUEs based on their location or the measured signal strength from the gNB 804 falling below a (pre-)configured threshold. Alternatively, this relaying may be triggered if existing future reservations by the neighboring vUE 806 overlaps with the resources cancelled by the gNB 804.

The relaying of the gNB SL resource cancellation may be performed through pre-emption. In particular, the cell edge vUE may send an SCI with the highest priority with a future dummy reservation overlapping the resources cancelled by the gNB. This dummy reservation subsequently triggers a pre-emption at the slot(s) indicated as cancelled by the gNB for all the neighboring vUEs with a lower priority. This relaying may also be performed in a manner similar to that of resource selection assistance. In particular, a new 2^{nd} stage SCI format or a MAC CE may be used to carry additional TRIV/FRIV fields dedicated to forwarding the cancellation request. In other words, the resources indicated by these TRIV/FRIV fields may be considered non-preferred and avoided by the neighboring out of coverage vUEs when they perform resource selection/reselection. In addition, this indication of the non-preferred resources may also trigger a pre-emption, such that the out of coverage vUEs are obliged to find alternative resources for their SL transmissions.

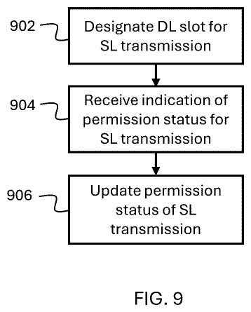

FIG. 9 is a flowchart illustrating a method for managing SL transmission in a DL slot, according to an embodiment. At 902, a UE may designate a DL slot of an UL-DL slot configuration period for an SL transmission.

At 904, the UE may receive, from a gNB, an indication of a permission status of the SL transmission. The indication may be received via a PDCCH, a MAC-CE, or RRC signaling. The indication may include information on a time domain location of the SL transmission in the UL-DL slot configuration period. The indication may also include information on a frequency domain location of the SL transmission in the UL-DL slot configuration period.

At 906, the UE may update the permission status of the SL transmission based on the indication. Updating the permission status may include cancelling or enabling the SL transmission based on the indication. Cancellation of the SL transmission may be applied semi-persistently across a plurality of UL-DL slot configuration periods. A start time for the cancellation across the plurality of UL-DL slot configuration periods may be defined based on whether the indication is received via the PDCCH or the MAC-CE.

A regular UE may be indicated to receive different DL RSs, such as, for example, a CSI-RS and an SSB, to conduct channel measurement, report to the gNB, or take necessary actions such as adjusting a reception beam. The variation in the presence of an SL transmission in some DL slots and the absence of an SL transmission may affect these measurements.

For different reporting quantities, if an RRC parameter timeRestrictionForChannelMeasurements or timeRestrictionForInterferenceMeasurements is set to “configured”, the UE derives the indicated channel or interference measurements using only the most recent (no later than the CSI reference resource) occasion of an SSB or CSI-RS. On the other hand, when the RRC parameter is set to “notconfigured”, UE implementation may determine which SSB(s) or CSI-RS(s) (and whether to average them or not), no later than the CSI reference resource, to derive the indicated channel or interference measurements.

If an SL transmission overlaps with some measured DL RSs (e.g., CSI-RS or SSB), in the DL slots, the measurements may reflect higher interference compared with DL RSs not colliding with SL transmission.

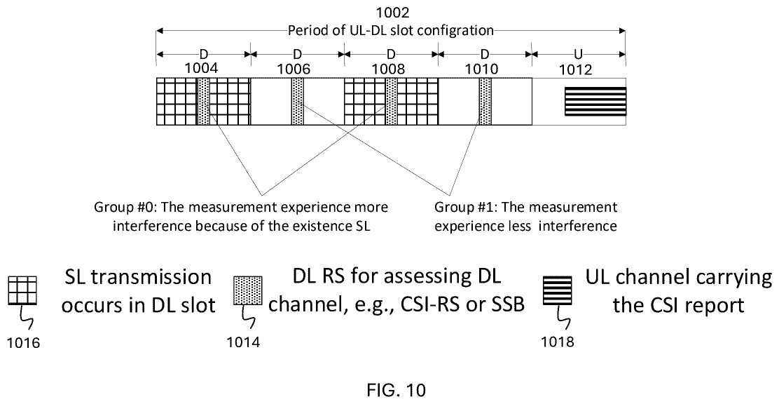

FIG. 10 is a diagram illustrating division of DL RSs into two groups based on a collision with an SL transmission, according to an embodiment. FIG. 10 illustrates an example of an UL-DL slot configuration period 1002, having five slots, in which the first four slots, 1004, 1006, 1008, 1010, are indicated as DL, and a last slot 1012 is indicated as UL (i.e., DDDDU).

More specifically, FIG. 10 shows an example of a periodic DL RS 1014, where some instances collide with an SL transmission 1016, referred to as Group #0, and other instances do not collide with the SL transmission 1016, referred to as Group #1. If the gNB indicates to the UE that no restriction is to be applied in terms of averaging, and if the UE derives a CSI report 1018 by averaging all the DL RSs, the CSI report 1018 may be corrupted. Different instances of the same RSs may experience different interference statistics.

The UE may derive a CSI report based on an averaging of the instances of DL RSs 1014 in one group. To determine which group to be used to derive the report may be predefined (e.g., provided in the specification).

Referring to FIG. 10, the DL RS instances 1014 in Group #0 may be used to derive a pessimistic CSI report.

Alternatively, the gNB may indicate which instances of DL RSs 1014 may be used for deriving the CSI report. For example, the gNB may use higher layer signaling, such as RRC parameter group_id, to indicate which DL RS instance group may be used. This parameter may part of the RRC configurations of the CSI report or the RRC configurations of the CSI-RS.

For CSI reports triggered by a MAC-CE (e.g., semi-persistent CSI report), an additional field may be introduced in the MAC-CE to indicate which DL RS instance group may be used to derive the triggered report. Similarly, for a CSI report triggered by PDCCH, an additional field may be introduced in the MAC-CE to indicate which DL RS instance group may be used to derive the triggered report. This field, in MAC-CE or PDCCH, may be in the form of a bitmap in which different bits correspond to different DL RS instance groups. Alternatively, the field may indicate an ID of the DL RS instance group.

For CSI reports triggered by MAC-CE or by PDCCH, the DL RS instance group that may be used for deriving the triggered CSI report may be configured by RRC signaling. For example, an RRC parameter indicating which DL RS instance group may be used may be included in the RRC configurations of the CSI report. In this scenario, when the CSI report is triggered by a MAC-CE or by a PDCCH, the UE may become aware of which group DL RS instances are to be used.

For such approach to work and to be able to identify the DL RS instance groups, the UE conducing the measurements needs to know when the DL RSs instances collide with an SL transmission. Accordingly, the gNB may indicate to this UE the time domain and frequency domain locations of the SL transmission. Such an indication may be provided by higher layer signaling, such as RRC signaling (i.e., semi-static indication). For example, a bitmap of particular length may be used in which each bit may correspond to a particular time domain resource (e.g., symbol, slot, subframe, UL-DL time division duplexing (TDD) period). Each bit may indicate whether this time domain resource has an SL transmission or not. In other words, each bit may indicate whether a DL RS instance belongs to the same group or a different group. This bitmap may be repeated back-to-back to indicate how to group DL RS IDs.

As illustrated in FIG. 10, the corresponding bitmap may be 01010 where each bit corresponds to a slot and values 0 and 1 refer to the slots counted as group #0 and group #1, respectively. Dynamic indication of the location of the SL transmission is described in greater detail below.

The gNB may indicate the start and duration for the periods in which the instances of DL RS belong to one group. The gNB may also indicate the periodicity for repeating such a pattern. For example, the gNB may indicate the pattern within a period and this pattern may be periodically repeated. In general, the aforementioned solutions for indicating the time location and frequency location of an SL transmission in DL slots to be cancelled or indicated as clear-to-transmit may be extended to provide the Uu UE with the location of SL transmissions in DL slots.

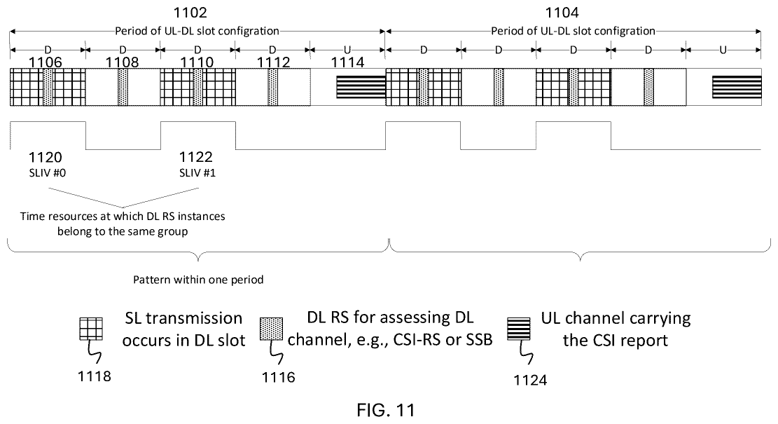

FIG. 11 is a diagram illustrating a pattern of time resources at which an SL transmission occurs, according to an embodiment. FIG. 11 illustrates an example of an UL-DL slot configuration periods 1102, 1104, having five slots, in which the first four slots, 1106, 1108, 1110, 1112, are indicated as DL, and a last slot 1114 is indicated as UL (i.e., DDDDU). More specifically, FIG. 11 shows an example of a periodic DL RS 1116, where some instances collide with an SL transmission 1118. A pattern of SL transmissions 1118 in the DL slot (i.e., the time resources that contain an SL transmission) may be indicated by configuring two SLIVs, SLIV #0 1120 and SLIV #1 1122. Additionally, the gNB may indicate to the UE the period in which this pattern is repeated. The last slot (e.g., UL slot 1114) may carry a CSI report 1124.

Referring to FIG. 11, the periodicity may be configured to be equal to the UL-DL slot configuration periods 1102, 1104. Therefore, the UE may derive the DL RS instances that belong to group #0 and group #1.

Furthermore, the gNB may configure the UE to generate two CSI reports 1124 based on the instances at which SL transmission occurs or does not occur, instead of just one. Therefore, it may be considered as two CSI reports transmitted in a single report occasion.

The gNB may semi-persistently indicate the presence/absence of SL transmission in the DL slot. The gNB may configure multiple patterns similar to the RRC based configurations. Then, the gNB may use MAC-CE to (de)activate one of the patterns.

Table 2 shows an example of possible configurations that the gNB may provide to the UE via higher layer signaling. Specifically, the gNB may configure multiple patterns in which each pattern includes the time durations at which an SL transmission occurs and periodicity for repeating.

Referring to Table 2, each pattern is assigned an index and includes single or multiple SLIVs indicating where the SL transmission occurs and the periodicity of the pattern. The gNB may transmit a MAC-CE to activate or deactivate single or multiple patterns. Though the time duration at which SL transmission occurs is indicated via SLIV, other approaches may be used as well, such as bitmap indicating the start and duration, or indicating the start and end location. Additionally, the gNB may configure the SCS to be used when interpreting parameters or the SCS of the currently active BWP may be used.

TABLE 2

| Pattern | |
|---|---|
| index | Pattern |
| #0 | SLIV #0, SLIV #1, and the corresponding periodicity |
| #1 | SLIV #2, SLIV #3, SLIV #4 and the corresponding periodicity |
| . . . | . . . |

Additionally, a UE-specific PDCCH or GC-PDCCH may be used to indicate the location of an SL transmission. The above-described operations may also be applied here. For example, a new field or multiple fields in the DCI may carry a single bitmap, multiple bitmaps, or SLIVs indicating the location of the SL transmission.

Before the UE becomes aware of the location of the SL transmission in which DL slots (e.g., MAC-CE) did not yet activate a pattern, the UE may treat all instances of the DL RS in the same manner. Specifically, the UE may be able to average any set of the instances of the DL RS when no restriction is configured. Nevertheless, after the UE becomes aware of which slots carry SL transmission(s), the UE may report the CSI based on the provided indication. The UE may report the CSI based on DL RS instances that collide with the SL transmission, or based on DL RS instances that do not collide with the SL transmission.

Alternatively, the UE may separately provide two CSI reports in the same reporting instance based on DL RS instances that collide with, and those do not collide with, the SL transmission.

The UE may need time to decode the MAC-CE carrying the indication and process the CSI report accordingly. For example, for an indication based on a MAC-CE, the indicated information may be applied on the CSI report, which starts from the first slot after slot n+3Nₛₗₒₜ^{subframeμ}, where n refers to the slot that UE would transmit HARQ-ACK information corresponding to the PDSCH carrying the MAC-CE, and μ is the SCS configuration for the channel carrying the HARQ-ACK information on the Uu interface.

For an indication carried via a PDCCH, the indication may be applied after k time units from the reception of the PDCCH. It may be in units of symbol, slot, subframe, UL-DL slot configuration period, and the like. The value of k may be predefined (e.g., provided in the specification, or indicated to the gNB via UE capability signaling).

Although the SLIV is used to indicate the location of the SL transmission, it may also be used to indicate the location at which the SL transmission does not occur to reduce the signaling overhead if a large number of SL transmissions are scheduled. In this case, an additional one-bit field may be needed or (pre-)configuration may be needed to indicate whether the SLIV is used to indicate the location with or without SL transmissions.

The UE may indicate to the gNB via capability signaling whether or not it supports such a feature. Additionally, the UE may indicate to the gNB whether it can generate the report based on the DL RS instances that collide with the SL transmission, or based on the DL RS instances that do not collide the SL transmission, or if two separate reports are generated each of which is based on a group of RS instances.

If the gNB indicates to UE to generate two separate CSI reports based on two separate groups of the DL RS instances based on whether they collides with SL transmission or not, the occupied processing units (PUs) may be counted properly to reflect the processing overhead. The number of occupied resources to generate the CSI report may be doubled. In other words, the report based on the DL RS instances colliding with the SL transmission and the report based on the DL RS instances not colliding with the SL transmission may be treated as if they are two separate reports associated with different RSs. For example, if in normal operation, without collision with SL transmission, X PUs are occupied, and two reports are required based on whether or not the instances of DL RSs collide with SL transmission, the number of occupied PUs becomes 2× PUs.

Some UEs may occupy fewer PUs (e.g., αX, where 0≤α≤2). The UE may indicate to the gNB the value of α via capability signaling. Additionally, the value of α may be predefined (e.g., provided in the specification).

Alternatively, to reflect the complexity of providing two CSI reports in the same reporting instance, the timeline for calculating a CSI report may be relaxed. The number of occupied PUs may remain unchanged. The timeline relaxation may be predefined or may be indicated via UE capability signaling.

Another rule may be applied to determine whether a DL RS instance is to be measured or not. For example, if the DL RS instance collides with an SL transmission, the UE may not measure it. Moreover, the decision may depend on the nature of the RS being periodic, semi-persistent, or dynamic. For example, for an instance of P/SP DL RS colliding with the SL transmission, the UE may ignore such an instance. However, for an instance of AP DL RS colliding the SL transmission, the UE may measure it and generate the corresponding report. Additionally, to determine which DL RS instances to measure and which to ignore, it may be either predefined, or configured via higher layer signaling.

Some DL RS may need to occupy a period of time (e.g., a CSI-RS used as a tracking RS (TRS) may need to occupy two consecutive slots). For such a DL RS, it may be challenging for the UE to process the case in which a portion of this duration collides with the SL transmission while another portion does not (e.g., the first slot of TRS collides with the SL transmission while the second slot of TRS does not collide with the SL transmission). Therefore, for a DL RS that should be transmitted over a certain duration of time, the UE may not expect a portion of this duration to collide with an SL transmission while another portion does not.

To enhance the scheduling flexibility at the gNB, as it may be hard to ensure that such collision does not occur, such a collision may be allowed. However, the UE is not expected to receive the entire DL RS. For example, if the first slot of TRS collides with the SL transmission while the next slot does not, the UE may not receive this instance of TRS.

If some UEs can handle such scenario, this feature may be indicated to the gNB via the UE's capability signaling.

Another rule is that for some important DL RS, such as TRS, the UE may not expect for it to collide with an SL transmission.

A DL synchronization signal (e.g., SSB) is important for both RRC connected and RRC idle/inactive UEs. Therefore, it may be beneficial to protect such a DL synchronization signal from the interference caused by the SL transmission. Therefore, the SL transmission may not occur or collide with DL synchronization signals that are actually transmitted. For example, if there is higher layer signaling indicating which of the DL synchronization signals are to be transmitted (e.g., ssb-PositionsInBurst), then only the DL synchronization signal that is indicated to be transmitted may not collide with the SL transmission. For other DL synchronization signals that are not indicated to be transmitted, an SL transmission may occur in the location if they would be transmitted.

Alternatively, the SL resource pool may be (pre-)configured such that the slots carrying the SSB signals are outside of the SL resource pool.

A vUE may be configured to receive P/SP DL RS on the Uu interface for deriving periodic CSI report or semi-persistent CSI report. The gNB may schedule the same vUE to transmit on the SL either dynamically or via higher layer signaling, colliding with the P/SP DL RS. Therefore, it may be beneficial to define the UE behavior in this scenario.

Table 3 and Table 4 show examples of the possible vUE behavior when collision occurs between P/SP/AP DL RS and P/SP/AP SL that may be predefined rules (e.g., provided in the specifications). Table 3 shows an assignment of higher priority to an SL transmission, compared with Table 4 that assigns higher priority to DL reception.

TABLE 3

| | P DL RS | SP DL RS | AP DL RS |
|---|---|---|---|
| Periodic SL | Not expected to occur | Not expected to occur | Not expected to occur |
| Semi- | Cancel the reception of the | Not expected to occur | Not expected to occur |
| persistent SL | P DL RS instance colliding | | |
| | with SP SL | | |
| Dynamic SL | Cancel the reception of the | Cancel the reception of | Not expected to occur |
| | P DL RS instance colliding | the SP DL RS instance | |
| | with AP SL | colliding with AP SL | |

TABLE 4

| | P DL RS | SP DL RS | AP DL RS |
|---|---|---|---|
| Periodic SL | Not expected to occur | Cancel the transmission | Cancel the transmission |
| | | of the P SL instance | of the P SL instance |
| | | colliding with SP DL | colliding with AP DL |
| | | RS reception | RS reception |
| Semi- | Not expected to occur | Not expected to occur | Cancel the transmission |
| persistent SL | | | of the SP SL instance |
| | | | colliding with AP DL |
| | | | RS reception |
| Dynamic SL | Not expected to occur | Not expected to occur | Not expected to occur |

Some exceptions may be applied to important DL RSs, such as a DL synchronization signal or a TRS. For example, when P DL RS is the DL synchronization signal, the vUE may prioritize the reception of DL RS and cancel the transmission of the SL during the collision period. Such important DL RSs may be predefined (e.g., provided in the specification). Alternatively, the gNB may configure a flag for such a DL RS to indicate that an exception may be applied for this DL RS. For example, if the flag is configured for particular P DL RS and one of its instances collides with a dynamic SL transmission, the vUE may prioritize the reception of P DL RS in the collision period over the transmission of the dynamic SL.

Another possibility is to determine the behavior of the vUE. In particular, either receiving the DL RS or transmitting an SL may depend on the priority of the reception on the Uu or the transmission on the SL. For example, the gNB may indicate the assigned priority to this DL RS either as part of the configurations of an DL RS or via a MAC-CE or PDCCH triggering such a DL RS. For example, when the priority of the SL transmission is above a pre-configured threshold and the DL priority is low, the vUE may prioritize the SL transmission and cancel the reception of the DL RS.

For the vUE to be able cancel reception of a DL RS or the transmission of an SL, the vUE may need some time.

Referring to Table 4 and considering the case in which the transmission of the P SL instance collides with AP DL RS reception, the UE may need some time from the instance of receiving PDCCH triggering AP DL RS until the beginning of the transmission of SL. For example, the time gap between PDCCH and first symbol of SL transmission may be required to be larger than the preparation time of the dynamic SL transmission.

Though the aforementioned description is for handling the collision between DL RS and SL RS, similar rules may be applied for collision between different DL channels/signals and SL channels/signals.

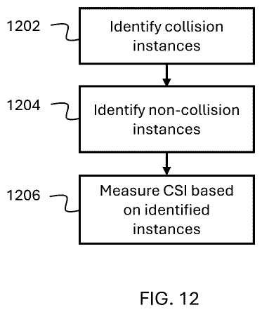

FIG. 12 is a flowchart illustrating a method for collision handling between DL RS reception and SL transmission, according to an embodiment. At 1202, a UE may identify collision instances of DL RS reception and SL transmission. A gNB may provide an indication of time domain locations for SL transmissions in the UL-DL slot configuration period. Alternatively, the gNB may provide an indication of DL RSs that collide with SL transmissions. At 1204, the UE may identify non-collision instances of DL RS reception.

At 1206, the UE may measure CSI based on at least one of the collision instances and the non-collision instances. The gNB may provide an indication to generate a CSI report. The UE may increase resources for generation of a first CSI report based on the collision instances and a second CSI report based on the non-collision instances.

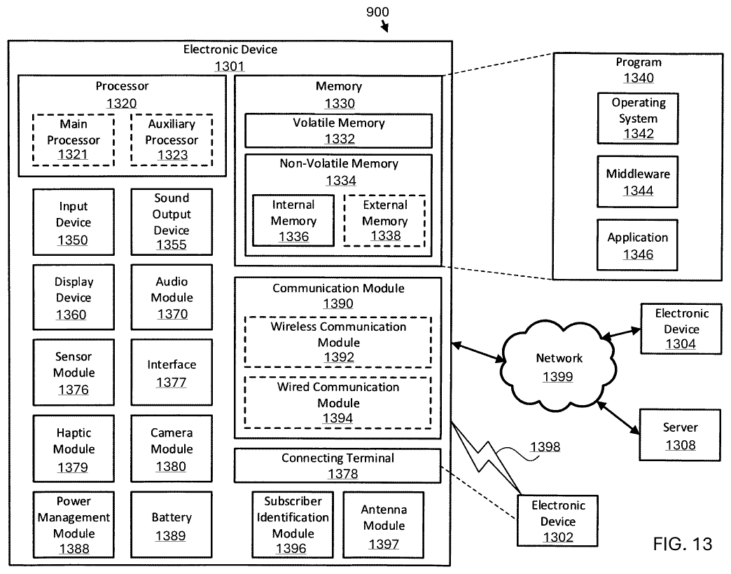

FIG. 13 is a block diagram of an electronic device in a network environment 1300, according to an embodiment.

Referring to FIG. 13, an electronic device (or UE) 1301 in a network environment 1300 may communicate with an electronic device 1302 via a first network 1398 (e.g., a short-range wireless communication network), or an electronic device 1304 or a server 1308 via a second network 1399 (e.g., a long-range wireless communication network). The electronic device 1301 may communicate with the electronic device 1304 via the server 1308. The electronic device 1301 may include a processor 1320, a memory 1330, an input device 1350, a sound output device 1355, a display device 1360, an audio module 1370, a sensor module 1376, an interface 1377, a haptic module 1379, a camera module 1380, a power management module 1388, a battery 1389, a communication module 1390, a subscriber identification module (SIM) card 1396, or an antenna module 1397. In one embodiment, at least one (e.g., the display device 1360 or the camera module 1380) of the components may be omitted from the electronic device 1301, or one or more other components may be added to the electronic device 1301. Some of the components may be implemented as a single integrated circuit (IC). For example, the sensor module 1376 (e.g., a fingerprint sensor, an iris sensor, or an illuminance sensor) may be embedded in the display device 1360 (e.g., a display).

The processor 1320 may execute software (e.g., a program 1340) to control at least one other component (e.g., a hardware or a software component) of the electronic device 1301 coupled with the processor 1320 and may perform various data processing or computations.

As at least part of the data processing or computations, the processor 1320 may load a command or data received from another component (e.g., the sensor module 1376 or the communication module 1390) in volatile memory 1332, process the command or the data stored in the volatile memory 1332, and store resulting data in non-volatile memory 1334. The processor 1320 may include a main processor 1321 (e.g., a CPU or an application processor (AP)), and an auxiliary processor 1323 (e.g., a GPU, an image signal processor (ISP), a sensor hub processor, or a communication processor (CP)) that is operable independently from, or in conjunction with, the main processor 1321. Additionally or alternatively, the auxiliary processor 1323 may be adapted to consume less power than the main processor 1321, or execute a particular function. The auxiliary processor 1323 may be implemented as being separate from, or a part of, the main processor 1321.

The auxiliary processor 1323 may control at least some of the functions or states related to at least one component (e.g., the display device 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). The auxiliary processor 1323 (e.g., an image signal processor or a communication processor) may be implemented as part of another component (e.g., the camera module 1380 or the communication module 1390) functionally related to the auxiliary processor 1323.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334. Non-volatile memory 1334 may include internal memory 1336 and/or external memory 1338.

The program 1340 may be stored in the memory 1330 as software, and may include, for example, an operating system (OS) 1342, middleware 1344, or an application 1346.

The input device 1350 may receive a command or data to be used by another component (e.g., the processor 1320) of the electronic device 1301, from the outside (e.g., a user) of the electronic device 1301. The input device 1350 may include, for example, a microphone, a mouse, or a keyboard.

The sound output device 1355 may output sound signals to the outside of the electronic device 1301. The sound output device 1355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1360 may visually provide information to the outside (e.g., a user) of the electronic device 1301. The display device 1360 may include, for example, a display, a hologram device, or a projector and control circuitry to control a corresponding one of the display, hologram device, and projector. The display device 1360 may include touch circuitry adapted to detect a touch, or sensor circuitry (e.g., a pressure sensor) adapted to measure the intensity of force incurred by the touch.

The audio module 1370 may convert a sound into an electrical signal and vice versa. The audio module 1370 may obtain the sound via the input device 1350 or output the sound via the sound output device 1355 or a headphone of an external electronic device 1302 directly (e.g., wired) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. The sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device 1302 directly (e.g., wired) or wirelessly. The interface 1377 may include, for example, a high-definition multimedia interface (HDMI), a universal serial bus (USB) interface, a secure digital (SD) card interface, or an audio interface.

A connecting terminal 1378 may include a connector via which the electronic device 1301 may be physically connected with the external electronic device 1302. The connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or an electrical stimulus which may be recognized by a user via tactile sensation or kinesthetic sensation. The haptic module 1379 may include, for example, a motor, a piezoelectric element, or an electrical stimulator.

The camera module 1380 may capture a still image or moving images. The camera module 1380 may include one or more lenses, image sensors, image signal processors, or flashes. The power management module 1388 may manage power supplied to the electronic device 1301. The power management module 1388 may be implemented as at least part of, for example, a power management integrated circuit (PMIC).

The battery 1389 may supply power to at least one component of the electronic device 1301. The battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the AP) and supports a direct (e.g., wired) communication or a wireless communication. The communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as BLUETOOTH™, wireless-fidelity (Wi-Fi) direct, or a standard of the Infrared Data Association (IrDA)) or the second network 1399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The antenna module 1397 may transmit or receive a signal or power to or from the outside (e.g., the external electronic device) of the electronic device 1301. The antenna module 1397 may include one or more antennas, and, therefrom, at least one antenna appropriate for a communication scheme used in the communication network, such as the first network 1398 or the second network 1399, may be selected, for example, by the communication module 1390 (e.g., the wireless communication module 1392). The signal or the power may then be transmitted or received between the communication module 1390 and the external electronic device via the selected at least one antenna.

Commands or data may be transmitted or received between the electronic device 1301 and the external electronic device 1304 via the server 1308 coupled with the second network 1399. Each of the electronic devices 1302 and 1304 may be a device of a same type as, or a different type, from the electronic device 1301. All or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1301. The electronic device 1301 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
designating, by a first user equipment (UE), a downlink (DL) slot of an uplink (UL)-DL slot configuration period for a sidelink (SL) transmission;
receiving, by the first UE, from a gNode B (gNB), an indication of a permission status of the SL transmission; and
updating, by the first UE, the permission status of the SL transmission based on the indication.

2. The method of claim 1, wherein the indication is received at the first UE via a physical downlink control channel (PDCCH), a medium access control-control element (MAC-CE), or radio resource control (RRC) signaling, and wherein updating the permission status of the SL transmission comprises:
cancelling the SL transmission based on the indication.

3. The method of claim 2, wherein the indication is received at the first UE via the MAC-CE or RRC signaling, and wherein cancelling the SL transmission comprises applying cancellation of the SL transmission semi-persistently or periodically across a plurality of UL-DL slot configuration periods.

4. The method of claim 2, wherein the indication comprises first information on a time domain location of the SL transmission in the UL-DL slot configuration period, and wherein the first information comprises a first bitmap, a start and length indicator value (SLIV), or priority-based information.

5. The method of claim 4, wherein the indication comprises second information on a frequency domain location of the SL transmission in the UL-DL slot configuration period, and wherein the second information comprises a second bitmap.

6. The method of claim 2, further comprising:
defining, by the first UE, a start time for cancellation of the SL transmission across UL-DL slot configuration periods based on whether the indication is received via the PDCCH or the MAC-CE.

7. The method of claim 2, further comprising:
performing, by the first UE, resource reselection based on cancellation of the SL transmission.

8. The method of claim 1, wherein updating the permission status of the SL transmission comprises:
enabling the SL transmission based on the indication.

9. The method of claim 1, further comprising:
transmitting, from the first UE, to the gNB, an indication that the UE has moved out of a coverage area of the gNB.

10. The method of claim 1, further comprising:
forwarding, by the first UE, the indication in SL control information (SCI) to a second UE.

11. A method comprising:
identifying, by a user equipment (UE), collision instances of downlink (DL) reference signal (RS) reception and sidelink (SL) transmission in an uplink (UL)-DL slot configuration period;
identifying, by the UE, non-collision instances of DL RS reception; and
measuring, by the UE, channel state information (CSI) based on at least one of the collision instances and the non-collision instances.

12. The method of claim 11, wherein identifying the collision instances comprises:
receiving, by the UE, from a gNode B (gNB), a first indication of time domain locations for SL transmissions in the UL-DL slot configuration period; or
receiving, by the UE, from the gNB, a second indication of DL RSs that collide with the SL transmissions.

13. The method of claim 11, further comprising:
receiving, by the UE, from the gNB, an indication to generate at least one CSI report based on at least one of the collision instances or the non-collision instances.

14. The method of claim 13, further comprising:
increasing, by the UE, processing resources for generation of or relaxing a processing timeline of a first CSI report based on the collision instances and a second CSI report based on the non-collision instances.

15. The method of claim 11, further comprising:
predefining a preference for DL RS reception or SL transmission, or configuring priorities for the DL RS reception and the SL transmission, within the identified collision instances.

16. A user equipment (UE) comprising:
a processor; and
a non-transitory computer readable storage medium storing instructions that, when executed, cause the processor to:
designate a downlink (DL) slot of an uplink (UL)-DL slot configuration period for a sidelink (SL) transmission;
receive, from a gNode B (gNB), an indication of a permission status of the SL transmission; and
update, by the UE, the permission status of the SL transmission based on the indication.

17. The UE of claim 16, wherein, in updating the permission status, the instructions further cause the processor to:
cancel the SL transmission based on the indication.

18. The UE of claim 16, wherein, in updating the permission status, the instructions further cause the processor to:
enable the SL transmission based on the indication.

19. The UE of claim 16, wherein the instructions further cause the processor to:
transmit, to the gNB, an indication that the UE has moved out of a coverage area of the gNB.

20. The UE of claim 16, wherein the instructions further cause the processor to:
forward the indication in SL control information (SCI) to a second UE.
